(19) United States
(12) Patent Application Publication
(10) Pub. No.: US 2024/0193508 A1
(43) Pub. Date: Jun. 13, 2024

(54) METHOD AND SYSTEM FOR EVALUATING FLIGHT STRING FATIGUE GRADE BASED ON TASK INFORMATION

(71) Applicant: Civil Aviation University of China, Tianjin (CN)

(72) Inventors: Jingqiang LI, Tianjin (CN); Annan LIU, Tianjin (CN); Huanxi ZHANG, Tianjin (CN); Xuemei WU, Tianjin (CN)

(21) Appl. No.: 18/523,500

(22) Filed: Nov. 29, 2023

(30) Foreign Application Priority Data
Dec. 8, 2022 (CN) 202211569304.0

(51) Int. Cl. G06Q 10/0631

(52) U.S. Cl. CPC G06Q 10/063116; G06Q 10/063118

(57) ABSTRACT

The disclosure discloses a method and a system for evaluating a flight string fatigue grade based on task information; the method includes: collecting task information of a flight string, and extracting first factors influencing a flight string fatigue degree based on the task information; constructing an index evaluation system based on the first factors, and calculating a weight coefficient of each of the first factors; carrying out a segment processing on the task information to obtain duty period segments; carrying out a quantitative characterization on the each of the first factors to obtain factor intensities of the duty period segments; calculating first fatigue values of the duty period segments based on the weight coefficients and the factor intensities; calculating a second fatigue value of the whole flight string based on the first fatigue values; and determining a flight string fatigue grade based on the second fatigue value.

### CROSS-REFERENCE TO RELATED APPLICATIONS

This disclosure claims priority to Chinese Patent Application No. 202211569304.0, filed on Dec. 8, 2022, the contents of which are hereby incorporated by reference.

### TECHNICAL FIELD

The disclosure belongs to the technical field of civil aviation scheduling data processing, and in particular to a method and a system for evaluating a flight string fatigue grade based on task information.

### BACKGROUND

Fatigue is a physiological state that people's performance is reduced due to excessive mental or physical activities, damages people's alertness, and the corresponding symptoms may include a short-term memory loss, an inattention, and an inability to maintain situational awareness. For civil aviation operations, improper work arrangements lead to pilot fatigue, which will endanger the physical and mental health of pilots, and even more seriously affect the reliability of flight operations and the ability to perform safety-related operational duties of the pilots. Fatigue is also considered to be the number one cause of human flight errors today. Fatigue is the combined effect of two main biological factors: the steady-state driving process of sleep and the circadian rhythm process. In view of this, the fatigue risk management for flight crew members is mainly based on limiting and demanding flight time, duty time and rest. However, the influence mechanism of fatigue in the real world is very complicated, and is related to many external influences, such as awakening time, time of day, workload, working environment and circadian rhythm. The management measures formulated by airlines for fatigue of pilots meet relevant civil aviation regulations, but the civil aviation regulations often only require the total amount of time, and do not consider more on-the-spot fatigue influencing factors; as a result, the difficulty of tasks assigned to pilots may be unbalanced, resulting in flight fatigue hidden dangers.

Flight string refers to the task route that the airline formulates for the aircrew according to the flight assembly requirements determined by the airline. It includes various flight tasks connected one after the other in time sequence, including one or more duty periods. After the flight string is made, the flight string is assigned to the appropriate pilots by the scheduling staff. The sequence of the flight string greatly improves the utilization efficiency of flight resources. However, once a node in the flight string is affected by uncertain factors, there may be a dynamic process in which the abnormal operation of the preceding flight is directly or indirectly transmitted to the following flight.

To sum up, fatigue, as a serious factor affecting the aviation safety, should be considered in the process of generating and allocating the flight strings. It is of great significance to evaluate the fatigue grade of the flight strings by using the factors such as time schedule, task environment and load that may be determined in the scheduling plan. At present, the research on quantifying or evaluating fatigue by using task information has been quite extensive, but there are still many shortcomings in practice:

First, at present, the evaluation of fatigue is mostly based on Biomathematical models (BMM), but BMM takes people as the evaluation object and predicts people's fatigue by using people's scheduling information. Therefore, it is not possible to use BMM to evaluate people's fatigue until the scheduling personnel finish the allocation between the flight strings and the pilots, and it is not possible to evaluate the fatigue degree of the flight strings in advance only aiming at the task arrangement of the flight strings.

Second, the formulation of flight strings is only carried out in accordance with the time-related restrictions and requirements stipulated by the regulations, and the complex causes of fatigue are not taken into account; in the allocation of flight strings, the evaluation of fatigue caused by flight strings mostly depends on the working experience of the scheduling personnel, lacking an objective evaluation tool, and limited by the ability level of the scheduling personnel, so it may be difficult for flight strings to achieve a balanced fatigue distribution.

### SUMMARY

The disclosure aims to provide a method and a system for evaluating a flight string fatigue grade based on task information. From perspectives of flight string design and distribution, aiming at the task arrangement of flight strings and considering influences of many fatigue influencing factors, a reasonable and comprehensive evaluation index system and an accurate and reliable index quantitative calculation model are established to quantitatively obtain a flight string fatigue degree and judge the fatigue grade.

In order to achieve the above objectives, the present disclosure provides a following scheme:

A method for evaluating a flight string fatigue grade based on task information includes following steps:

S1, collecting task information of a flight string, and extracting first factors influencing a flight string fatigue degree based on the task information;

S2, constructing an index evaluation system based on the first factors, and calculating a weight coefficient of each of the first factors;

S3, carrying out a segment processing on the task information to obtain duty period segments; carrying out a quantitative characterization on the each of the first factors to obtain factor intensities of the duty period segments;

S4, calculating first fatigue values of the duty period segments based on the weight coefficients and the factor intensities; and

S5, calculating a second fatigue value of the whole flight string based on the first fatigue values; and determining a flight string fatigue grade based on the second fatigue value.

Optionally, the first factors include: a duty duration, a duty start time, a duty end time, a take-off and landing time, a stop-over duration, a flight direction and crossing time zones, an airport difficulty, a pre-order duty and rest, a number of flight segments and staffing.

Optionally, a method for constructing the index evaluation system includes:

classifying the first factors to obtain first-level indexes;

taking the first factors included in the first-level indexes as second-level indexes; and

constructing the index evaluation system based on the first-level indexes and the second-level indexes.

Optionally, the first-level indexes include:

time planning factors, environmental factors and workload factors.

Optionally, a method for obtaining the factor intensities includes:

carrying out the quantitative characterization on the first factors, and setting an upper limit fₜₒₚ and a lower limit f_{down} of an influence of a quantitative characterization result on duty fatigue for first factors with not-normalized quantitative characterization; and

carrying out a normalization processing on quantized first factors to obtain a factor intensity of the each of the first factors.

Optionally, a calculation method of the normalization processing is as follows:

$$Q = \{ \begin{matrix}1 & ; f \geq {f}_{top} \\ \frac{f - {f}_{down}}{{f}_{top} - {f}_{down}} & ; {f}_{top} > f > {f}_{down} \\ 0 & ; {f}_{down} \geq f\end{matrix}$$

where Q represents the factor intensity and f represents a characterization result.

The disclosure also provides a system for evaluating a flight string fatigue grade based on task information, and the system includes a collection module, a system construction module, a processing module, a calculation module and an analysis module;

where the collection module is used for collecting task information of a flight string, and extracting first factors influencing a flight string fatigue degree based on the task information;

the system construction module is used for constructing an index evaluation system based on the first factors, and calculating a weight coefficient of each of the first factors;

the processing module is used for carrying out a segment processing on the task information to obtain duty period segments; carrying out a quantitative characterization on the each of the first factors to obtain factor intensities of the duty period segments;

the calculation module is used for calculating first fatigue values of the duty period segments based on the weight coefficients and the factor intensities; and

the analysis module is used for calculating a second fatigue value of the whole flight string based on the first fatigue values; and determining a flight string fatigue grade based on the second fatigue value.

Optionally, a method for constructing an evaluation index by the system construction module includes:

classifying the first factors to obtain first-level indexes;

taking the first factors contained in the first-level indexes as second-level indexes; and

constructing the index evaluation system based on the first-level indexes and the second-level indexes.

Optionally, a method for obtaining the factor intensities by the processing module includes:

carrying out the quantitative characterization on the first factors, and setting an upper limit fₜₒₚ and a lower limit f_{down} of an influence of a quantitative characterization result on duty fatigue for first factors with not-normalized quantitative characterization; and

carrying out a normalization processing on quantized first factors to obtain a factor intensity of the each of the first factors.

Optionally, a calculation method of the normalization processing is as follows:

$$Q = \{ \begin{matrix}1 & ; f \geq {f}_{top} \\ \frac{f - {f}_{down}}{{f}_{top} - {f}_{down}} & ; {f}_{top} > f > {f}_{down} \\ 0 & ; {f}_{down} \geq f\end{matrix}$$

where Q represents the factor intensity and f represents a characterization result.

The disclosure has following beneficial effects.

According to the method and the system for evaluating the flight string fatigue grade based on task information provided by the disclosure, from perspectives of flight string design and distribution, aiming at the task arrangement of flight strings and considering influences of many fatigue influencing factors, a reasonable and comprehensive evaluation index system and an accurate and reliable index quantitative calculation model are established to quantitatively obtain a flight string fatigue degree and judge the fatigue grade; compared with the conventional flight string design and the subjective judgment of the scheduling personnel, the disclosure can judge the fatigue grade of the flight string more comprehensively and objectively. The disclosure may be combined with the flight company's scheduling tool, and may be used as a reference tool for the scheduling personnel to match the flight strings with the pilots while improving the fatigue evaluation efficiency of the flight string, so as to facilitate more balanced matching between the flight strings and the pilots, thereby reducing fatigue risks.

### BRIEF DESCRIPTION OF THE DRAWINGS

In order to explain the technical scheme of the present disclosure more clearly, the drawings needed in the embodiments are briefly introduced below. Obviously, the drawings in the following description are only some embodiments of the present disclosure. For ordinary people in the field, other drawings may be obtained according to these drawings without paying creative labor.

FIG. 1 is a flowchart of a method for evaluating a flight string fatigue grade based on task information according to an embodiment of the present disclosure.

FIG. 2 is a schematic structural diagram of a system for evaluating a flight string fatigue grade based on task information according to an embodiment of the present disclosure.

### DETAILED DESCRIPTION OF THE EMBODIMENTS

In the following, the technical scheme in the embodiment of the disclosure will be clearly and completely described with reference to the attached drawings. Obviously, the described embodiment is only a part of the embodiment of the disclosure, but not the whole embodiment. Based on the embodiments in the present disclosure, all other embodiments obtained by ordinary technicians in the field without creative labor belong to the scope of protection of the present disclosure.

In order to make the above objects, features and advantages of the present disclosure more obvious and easier to understand, the present disclosure is further described in detail with the attached drawings and specific embodiments.

### Embodiment 1

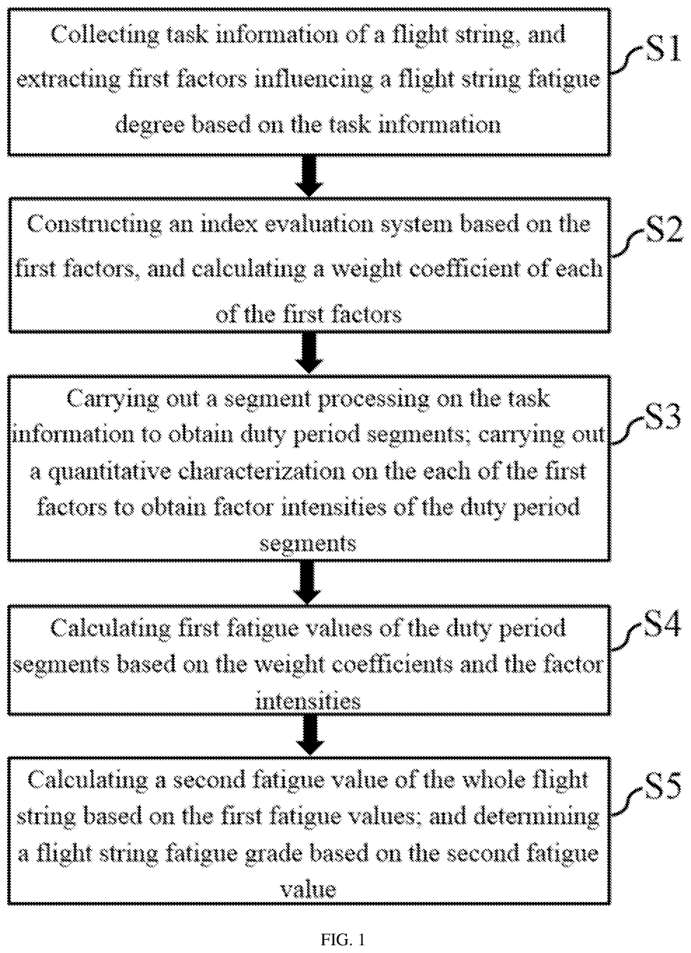

As shown in FIG. 1, FIG. 1 is a flowchart of a method for evaluating a flight string fatigue grade based on task information of the present disclosure, including following steps:

S1, collecting task information of a flight string, and extracting first factors influencing a flight string fatigue degree based on the task information;

in this embodiment, the first factors affecting a fatigue degree of the flight string include: a duty duration, a duty start time, a duty end time, a take-off and landing time, a stop-over duration, a flight direction and crossing time zones, an airport difficulty, a pre-order duty and rest, a number of flight segments and staffing.

S2, constructing an index evaluation system based on the first factors, and calculating a weight coefficient of each of the first factors;

where a method for constructing the index evaluation system includes:

S21, classifying the first factors to obtain first-level indexes;

in this embodiment, the first-level indexes are classifications of flight string fatigue influencing factors; the above-mentioned first factors are classified to obtain the first-level indexes including time planning factors, environmental factors and workload factors.

S22, taking the first factors included in the first-level indexes as second-level indexes;

where the time planning factors include secondary indicators such as the duty duration, the duty start time, the duty end time, the take-off and landing time; the environmental factors include secondary indicators such as the flight direction and crossing time zones and the airport difficulty; the workload factors include secondary indicators such as the pre-order duty and rest, the number of flight segments and staffing.

S23, constructing an index evaluation system based on the first-level indexes and the second-level indexes, and calculating a weight coefficient of each of the first factors. As shown in Table 1, where the characters in ( )in Table 1 represent the weights of each index.

TABLE 1

| First-level indexes | Second-level indexes |
|---|---|
| Time planning factors (A) | Duty duration (a1) |
| | Duty start time (a2) |
| | Duty end time (a3) |
| | Take-off and landing time (a4) |
| | stop-over duration (a5) |
| Environmental factors (B) | Flight direction and crossing time zones (b1) |
| | Airport difficulty (b2) |
| Workload factors (C) | pre-order duty and rest (c1) |
| | Number of flight segments (c2) |
| | Staffing (c3) |

A method for calculating the weight coefficient of each of the first factors includes: in this embodiment, the index weights determined by the 1-9 ratio scale method satisfy following relationships: a+b+c=1; a1+a2+a3+a4+a5=1; b1+b2=1; c1+c2+c3=1; the weight coefficients of each of the first factors are: Wa1=A×a1, Wa2=A×a2, Wa3=A×a3, Wa4=A×a4, Wa5=A×a5, Wb1=B×b1, Wb2=B×b2, Wc1=C×c1, Wc2=C×c2, and Wc3=C'c3.

In this implementation, the determined index evaluation system and the weight coefficients of the first factors are shown in Table 2:

TABLE 2

| | | Weight coefficients W |
|---|---|---|
| First-level indexes | Second-level indexes | of impact factors |
| Time planning | Duty duration (0.3) | 0.15 |
| factors | Duty start time (0.22) | 0.11 |
| (0.51) | Duty end time (0.15) | 0.075 |
| | Take-off and landing time | 0.085 |
| | (0.17) | |
| | Stop-over duration (0.16) | 0.08 |
| Environmental | Flight direction and | 0.13 |
| factors | crossing time zones (0.65) | |
| (0.19) | Airport difficulty (0.35) | 0.07 |
| Workload factors | Pre-order duty and rest | 0.105 |
| (0.3) | (0.35) | |
| | Number of flight segments | 0.105 |
| | (0.35) | |
| | Staffing (0.3) | 0.09 |

S3, carrying out a segment processing on the task information to obtain duty period segments; carrying out a quantitative characterization on the each of the first factors to obtain factor intensities of the duty period segments;

The task information of the flight string in this embodiment is shown in Table 3, and the task information is divided into three duty segments:

TABLE 3

| | | | | | Three- | Three- | | | | |
|---|---|---|---|---|---|---|---|---|---|---|
| Number | Duty | Duty | Task | Task | character | character | | Number | Number | Number |
| of duty | start | end | start | end | code of the | code of the | Task | of | of first | of second |
| segments | time | time | time | time | start airport | end airport | type | captains | officers | officers |
| 1 | 2022 Sep. 2 | 2022 Sep. 2 | 2022 Sep. 2 | 2022 Sep. 2 | XMN | CGO | Fly | 1 | 1 | 0 |
| | 9:30 | 20:38 | 10:30 | 10:50 | | | | | | |
| | | | 2022 Sep. 2 | 2022 Sep. 2 | CGO | BKK | Fly | 1 | 1 | 0 |
| | | | 13:50 | 19:38 | | | | | | |
| | | | 2022 Sep. 2 | 2022 Sep. 3 | BKK | BKK | Stay over | 1 | 1 | 0 |
| | | | 20:38 | 7:30 | | | night | | | |
| 2 | 2022 Sep. 3 | 2022 Sep. 3 | 2022 Sep. 3 | 2022 Sep. 3 | BKK | XMN | Fly | 1 | 1 | 0 |
| | 7:30 | 14:30 | 9:27 | 12:30 | | | | | | |
| | | | 2022 Sep. 3 | 2022 Sep. 4 | XMN | XMN | Stay over | 1 | 1 | 0 |
| | | | 14:30 | 7:00 | | | night | | | |
| 3 | 2022 Sep. 4 | 2022 Sep. 4 | 2022 Sep. 4 | 2022 Sep. 4 | XMN | LXA | Fly | 1 | 1 | 0 |
| | 7:00 | 12:38 | 7:35 | 11:33 | | | | | | |
| | | | 2022 Sep. 4 | 2022 Sep. 4 | LXA | XMN | Setting | 1 | 1 | 0 |
| | | | 11:33 | 11:38 | | | | | | |
| | | | 2022 Sep. 4 | 2022 Sep. 4 | XMN | XMN | Rest after | 1 | 1 | 0 |
| | | | 12:38 | 22:38 | | | flight | | | |

Firstly, obtaining the quantitative characterization of each of the first factors for the first duty segment and then carrying out a normalization; after the normalization, setting an upper limit fₜₒₚ and a lower limit f_{down} of an influence of a quantitative characterization result on duty fatigue for first factors with not-normalized quantitative characterization; carrying out a normalization processing on quantized first factors to calculate a factor intensity of the each of the first factors:

a calculation method of the normalization processing is as follows:

$$Q = \{ \begin{matrix}1 & ; f \geq {f}_{top} \\ \frac{f - {f}_{down}}{{f}_{top} - {f}_{down}} & ; {f}_{top} > f > {f}_{down} \\ 0 & ; {f}_{down} \geq f\end{matrix}$$

where Q represents the factor intensity and f represents a characterization result.

In the first duty segment, for “duty duration”, a steady-state function is used to characterize the relationship between the duty duration and the fatigue degree, and the quantitative expression is as follows:

$$f = τ \cdot ( 1 - {e}^{- \frac{t}{τ}} ) ;$$

in the formula, t represents the duty duration, and τ represents a constant in the functional expression of the relationship between the duty duration and the fatigue degree. In this embodiment, t=10.13 hours, τ=8; an influence of a quantitative characterization of the duty duration on duty fatigue has an upper limit fₜₒₚ=f(t=17)≈7.04, and a lower limit f_{down}=f(t=3)≈2.5; the quantitative characterization of the duty duration f(t=10.13)≈5.74 is between the upper limit and the lower limit, so it is normalized by a normalization formula as the factor intensity of the duty duration.

For “duty start time” and “duty end time”: within the working scope of the two first factors, a simple circadian rhythm function is used to characterize the relationship between the duty start time/the duty end time and the fatigue degree, and the quantitative expression is as follows:

$$f = \{ \begin{matrix}0.5 \cdot cos ( \frac{2 π ( td - {td}_{h} )}{24} ) + 0.5 , & {td}_{l 1} < td < {td}_{l 2} \\ 0 , & td \leq {td}_{l 1} or {td}_{l 2} \leq td\end{matrix} ;$$

where td represents the starting/ending time of duty; a duty starting or ending between tdₗ₁ and tdₗ₂ has an influence on fatigue, and a duty starting or ending at tdₕ has the strongest influence on fatigue. When td is beyond tdₗ₁ point to tdₗ₂ point, the value of the quantitative characterization is 0.

For “duty start time”, in this embodiment, td=9.5, tdₗ₁=20, tdₗ₂=6 (+1 day), tdₕ=1, and an influence of a quantitative characterization of the duty start time on duty fatigue has an upper limit fₜₒₚ=f(td=1)=1, and a lower limit f_{down}=f(td=20)≈0.63; in this embodiment, the quantitative characterization of the duty start time is f(td=9.5)≤f_{down}, so the factor intensity is 0.

For the “duty end time”, in this embodiment, td=20.63, tdₗ₁=22, tdₗ₂=8 (+1 day), tdₕ=3, and an influence of a quantitative characterization of the duty end time on duty fatigue has an upper limit fₜₒₚ=f(td=3)=1, and a lower limit f_{down}=f(td=22)≈0.63; in the embodiment, the quantitative characterization of the duty end time is f(td=20.63)≤f_{down}, so the factor intensity is 0.

For “take-off and landing time”: within the working scope of the first factor, a quantitative expression of the influence of the take-off and landing time of a flight task in one duty on the whole duty fatigue is as follows:

$$f = {\sum }_{i = 1}^{nf} \{ \begin{matrix}0.5 \cdot cos ( \frac{2 π ( {tf}_{i} - {tf}_{h} )}{24} ) + 0.5 , & {tf}_{l 1} < {tf}_{i} < {tf}_{l 2} \\ 0 , & {tf}_{i} \leq {tf}_{l 1} or {tf}_{l 2} \leq {tf}_{i}\end{matrix}$$

where in the formula, tf₁, tf₂, . . . , tf_{nf} are take-off and landing time points of nf tasks after tfₗ₁ and before tfₗ₂; taking-off and landing between tfₗ₁ and tfₗ₂ have an influence on fatigue, and taking-off and landing at tfₕ have a strong influence on fatigue. In this embodiment, tfₗ₁=0, tfₗ₂=6 and tfₕ=3, and there are two flight tasks with four take-offs and landings, with time points of 10.5, 10.83, 13.83 and 19.63 respectively. An influence of a quantitative characterization of the take-off and landing time on duty fatigue has an upper limit fₜₒₚ=f(tf={3, 3, 3})=3, and a lower limit f_{down}=0; in the embodiment, the quantitative characterization of the take-off and landing time is f(tf={10.5, 10.83, 13.83, 19.63})≤f_{down}, so the factor intensity is 0.

For “stop-over duration”: within the working scope of the first factors, a quantitative expression of the influence of the stop-over duration in one duty on the whole duty fatigue is as follows:

$$f = {\sum }_{i = 1}^{nw} \{ \begin{matrix}\frac{{tw}_{i} - {tw}_{l 1}}{{tw}_{h} - {tw}_{l 1}} , & tw \leq {tw}_{h} \\ 1 - \frac{{tw}_{i} - {tw}_{h}}{{tw}_{l 2} - {tw}_{h}} , & tw > {tw}_{h}\end{matrix}$$

where tw₁, tw₂, . . . , tw_{nw} are nw stop-over durations after twₗ₁ and before twₗ₂; the stop-over duration between twₗ₁ and twₗ₂ has an influence on fatigue; twₕ represents a critical stop-over duration during which guest rest should be arranged according to the plan, and when the stop-over duration is twₕ, it has the strongest impact on fatigue; in this embodiment, twₗ₁=1 h, twₗ₂=8 h, twₕ=3 h, and there is one stopover for 3 hours; an influence of a quantitative characterization of the stop-over duration on duty fatigue has an upper limit fₜₒₚ=f(tw={3, 3})=2, and a lower limit f_{down}=0; in the embodiment, the quantitative characterization of the stop-over duration f(tw={3})=1, and is between the upper limit and the lower limit, so the quantitative characterization of the stop-over duration is normalized by a normalization formula, and then is taken as the factor intensity of the duty time.

For “flight direction and crossing time zone”: a quantitative expression of the influence of nz times of crossing time zones in one duty on the whole duty fatigue is as follows:

$$f = {\sum }_{i = 1}^{nz} {dir}_{i} \cdot {tz}_{i}$$

where tz₁, tz₂, . . . , tz_{nz} are numbers of latitude and longitude time zones spanned by nz tasks; dir₁, dir₂, . . . , dirₚ represent impact coefficients between the flight direction and the flight string fatigue, and if the number of cross-time zones is within the lower limit of fatigue, dir=0; when the number of cross-time zones impacts on fatigue, dir=1 when flying west, dir=dir′ when flying east, and dir′ represents an overall fatigue ratio between the eastbound flight route and the westbound flight route. In this embodiment, crossing three time zones is assumed as the lower limit of the number of crossing time zones on fatigue, dir′=1.1, and there are two flight tasks (Xiamen XMN-Zhengzhou CGO, Zhengzhou CGO-Bangkok BKK) in the first duty segment, and the number of crossing time zones crossing is 0, 1 (flying west), that is, dir={0, 0}, tz={0, 1}; an influence of a quantitative characterization of the flight direction and crossing time zones on duty fatigue has an upper limit fₜₒₚ=f(dir={1.1, 1.0}, tz={10, 10})=21, and a lower limit f_{down}=0; in the embodiment, the quantitative characterization of the flight direction and crossing time zones is f(dir={0, 0}, tz={0, 1})≤f_{down}, so the factor intensity is 0.

For “airport difficulty”: a quantitative expression of the influence of the airport difficulty of np flight tasks landing at the airport in one duty on the whole duty fatigue is as follows:

$$f ( p ) = {\sum }_{i = 1}^{np} {p}_{i}$$

where p₁, p₂, . . . , pₙₚ respectively represent difficulty scores of np landing airports; difficulties of the airports are classified and scored according to altitude, terrain, crosswind and landing procedures of the airports, and the classification and scoring depends on the pilot's evaluation. In this embodiment, airports requiring a special captain qualification are classified as Class A, and high-altitude airports requiring a special captain qualification are classified as Class B. Scored depends on the pilot's evaluation, airports except Class A and Class B are given 0, and airports of Class A and Class B are given 2.5 and 5.6 respectively. An influence of a quantitative characterization of the airport difficulty on duty fatigue has an upper limit fₜₒₚ=f(p={5.6, 2.5})=8.1, and a lower limit f_{down}=0; in the embodiment, the quantitative characterization of the airport difficulty is f(p={0, 0})≤f_{down}, so the factor intensity is 0.

For “pre-order duty and rest”: the quantitative expression within the working scope of the first factors is as follows:

$$f = \frac{sco}{tb}$$

where sco represents an assigned value of the pre-order duty, and tb represents a number of interval hours between this duty and the pre-order duty; a first duty or interval hours tb higher than a full rest critical time tbₕ in the flight string has no effect on the duty fatigue, that is, the quantitative characterization is equal to 0. In this embodiment, an influence of a quantitative characterization of the pre-order duty and rest on duty fatigue has an upper limit fₜₒₚ=f(sco=50, tb=10)=5, and a lower limit f_{down}=f(sco=10, tb=20)=0.5; in this embodiment, the duty is the first duty, and the quantitative characterization of the pre-order duty and rest is f≤f_{down}, so the factor intensity is 0.

For “number of flight segments”: the quantitative expression of the number of flight segments is the number of flight segments itself. In this embodiment, an influence of a quantitative characterization of the number of flight segments on duty fatigue has an upper limit fₜₒₚ=6, and a lower limit f_{down}=2, the number of flight segments is 2, and the quantitative characterization of the number of flight segments f=2 is between the upper limit and the lower limit, so it is normalized by a normalization formula as the factor intensity of the duty duration.

For “staffing”, the quantitative expression of the staffing is as follows:

f=ca+fo·ab1+so·ab2

where ca, fo and so represents numbers of the captains, the first officers and the second officers respectively; ab1 and ab2 represents flight strength ratios of the first officer and the second officer to the captain respectively, and the specific ratios are obtained by scoring pilots through investigation. In this embodiment, ab1=0.75 and ab2=0.5; an influence of a quantitative characterization of the staffing on duty fatigue has an upper limit fₜₒₚ=f(ca=3, fo=0, so=3)=4.5, and a lower limit f_{down}=f(ca=1, fo=0, so=0)=1; the quantitative characterization of the staffing f(ca=1, fo=1, so=0, ab1=0.75, ab2=0.5)=1.75 is between the upper limit and the lower limit, so it is normalized by a normalization formula as the factor intensity of the duty duration.

The quantitative characterization and the factor intensity of each first factor in the first duty segment are shown in Table 4:

TABLE 4

| | Quantified | | | |
|---|---|---|---|---|
| | characteri- | Lower | Upper | Factor |
| | zation | limits of | limits of | inten- |
| First factors | values | influence | influence | sities |
| Duty duration | 5.74 | 2.5 | 7.04 | 0.71 |
| Duty start time | 0 | 0.63 | 1 | 0 |
| Duty end time | 0 | 0.63 | 1 | 0 |
| Takeoff and landing time | 0 | 0 | 3 | 0 |
| Stop-over duration | 1 | 0 | 2 | 0.5 |
| Flight direction and | 0 | 0 | 21 | 0 |
| crossing time zones zone | | | | |
| Airport difficulty | 0 | 0 | 8.1 | 0 |
| Pre-order duty and rest | 0 | 0.5 | 5 | 0 |
| Number of flight segments | 2 | one | 6 | 0.2 |
| Staffing | 1.75 | one | 4.5 | 0.2 |

S4, calculating first fatigue values of the duty period segments based on the weight coefficients and the factor intensities;

a first fatigue value F of each duty segment is calculated by the above-mentioned weight coefficient W and the factor intensity Q, and the specific calculation method is as follows:

$$F = α \cdot {\sum }_{i = 1}^{m} ( {Q}_{i} \cdot {W}_{i} )$$

where α represents an adjustment coefficient used for modifying an output range of the model; m represents a number of first factors affecting flight string fatigue; Qᵢ and Wᵢ are a factor intensity and a weight coefficient of the i-th first factor respectively. In this embodiment, α=100, representing an output range of 0-100;

first fatigue values of other duty segments in the flight string are shown in Table 5:

TABLE 5

| | Duty segments | | | | | |
|---|---|---|---|---|---|---|
| | 1 | | 2 | | 3 | |
| | Factor | First | Factor | First | Factor | First |
| | inten- | fatigue | inten- | fatigue | inten- | fatigue |
| | sities | values | sities | values | sities | values |
| Duty duration | 0.71 | | 0.48 | | 0.34 | |
| Duty start time | 0 | | 0 | | 0 | |
| Duty end time | 0 | | 0 | | 0 | |
| Takeoff and | 0 | | 0 | | 0 | |
| landing time | | | | | | |
| Stop-over | 0.5 | | 0 | | 0 | |
| duration | | | | | | |
| Flight direction | 0 | 12.55 | 0 | 6.25 | 0 | 6.42 |
| and crossing | | | | | | |
| time zones | | | | | | |
| Airport dif- | 0 | | 0 | | 0.14 | |
| ficulty | | | | | | |
| Pre-order duty | 0 | | 0.21 | | 0.02 | |
| and rest | | | | | | |
| Number of | 0.2 | | 0 | | 0.2 | |
| flight segments | | | | | | |
| Crew staffing | 0.21 | | 0.21 | | 0.21 | |

S5, calculating a second fatigue value of the whole flight string based on the first fatigue values; and determining a flight string fatigue grade based on the second fatigue value.

The method for calculating the second fatigue value of the whole flight string is as follows:

First, averaging the first fatigue values F of each duty segment to obtain an average quantized value R̅F̅ of the duty fatigue degree in the whole flight string, and the calculation formula is as follows:

$$\overline{RF} = \frac{1}{n} {\sum }_{i = 1}^{n} {F}_{i}$$

where n represents number of duty segments in the flight string;

then, calculating a standard deviation σ of the fatigue degree of n duty segments in the flight string according to the fatigue degree quantified value Fᵢ of each duty segment and the average quantized value R̅F̅ of the duty fatigue degree in the whole flight string, and the formula is as follows:

$$σ = \sqrt{\frac{1}{n} {\sum }_{i = 1}^{n} {( {F}_{i} - \overline{RF} )}^{2}} ;$$

then, calculating a skewness coefficient S of the fatigue degree of n duty segments in the flight string according to fatigue degree quantified value Fᵢ of each duty segment, the average quantized value R̅F̅ of the duty fatigue degree in the whole flight string and the standard deviation σ, and the formula is as follows:

$$S = {\sum }_{i = 1}^{n} \frac{{( {F}_{i} - \overline{RF} )}^{3}}{{σ}^{3}}$$

finally, calculating TF representing the second fatigue value of the whole flight string according to the average quantized value R̅F̅ of the duty fatigue degree of n duty segments in the flight string and the skewness coefficient S, and the formula is as follows:

TF=R̅F̅+S.

In this embodiment, the average quantized value R̅F̅ of the duty fatigue degree of n duty segments in the flight string=8.4, the standard deviation σ=2.93, the skewness coefficient S=1.73, and the quantized value representing the fatigue degree of the whole flight string TF=10.13.

A method for determining the fatigue grade of the flight string based on the second fatigue value includes:

when TF>80, the fatigue grade is Grade IV;

when 80≥TF>50, the fatigue grade is Grade III;

when 50≥TF>20, the fatigue grade is Grade II;

when TF≤20, the fatigue grade is Grade I;

where the fatigue grade Grade IV represents that the flight sequence task arrangement may make people extremely tired; the fatigue Grade III represents that the flight sequence task arrangement may make people highly tired; the fatigue Grade II represents that the flight sequence task arrangement may make people generally tired; and the fatigue Grade I represents that the flight schedule may make people moderately tired (or not tired).

### Embodiment 2

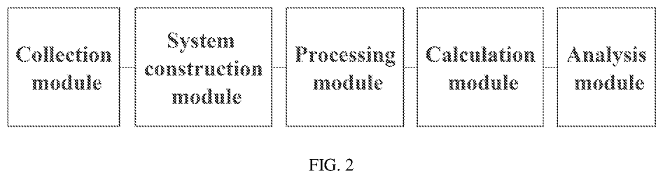

As shown in FIG. 2, FIG. 2 is a structural schematic diagram of a flight string fatigue rating system based on task information, including a collection module, a system construction module, a processing module, a calculation module and an analysis module.

The collection module is used for collecting task information of a flight string, and extracting first factors influencing a flight string fatigue degree based on the task information;

in this embodiment, the first factors affecting a fatigue degree of the flight string include: a duty duration, a duty start time, a duty end time, a take-off and landing time, a stop-over duration, a flight direction and crossing time zones, an airport difficulty, a pre-order duty and rest, a number of flight segments and staffing.

The system construction module is used for constructing an index evaluation system based on the first factors, and calculating a weight coefficient of each of the first factors.

A method for constructing the index evaluation system by the system construction module block includes following steps:

(1) classifying the first factors to obtain first-level indexes;

in this embodiment, the first-level indexes are classifications of flight string fatigue influencing factors; the above-mentioned first factors are classified to obtain the first-level indexes including time planning factors, environmental factors and workload factors;

(2) taking the first factors included in the first-level indexes as second-level indexes;

where the time planning factors include secondary indicators such as the duty duration, the duty start time, the duty end time, the take-off and landing time; the environmental factors include secondary indicators such as the flight direction and crossing time zones and the airport difficulty; the workload factors include secondary indicators such as the pre-order duty and rest, the number of flight segments and staffing; and

(3) constructing an index evaluation system based on the first-level indexes and the second-level indexes.

A method for calculating the weight coefficient of each of the first factors includes: in this embodiment, the weight of each index determined by the 1-9 ratio scale method.

The processing module is used for carrying out a segment processing on the task information to obtain duty period segments; carrying out a quantitative characterization on the each of the first factors to obtain factor intensities of the duty period segments.

In this embodiment, the task information is divided into three duty segments:

taking the first duty segment as an example, the method for processing the module to obtain the factor intensity includes:

Firstly, obtaining the quantitative characterization of each of the first factors for the first duty segment and then carrying out a normalization; after the normalization, setting an upper limit fₜₒₚ and a lower limit f_{down} of an influence of a quantitative characterization result on duty fatigue for first factors with not-normalized quantitative characterization; carrying out a normalization processing on quantized first factors to calculate a factor intensity of the each of the first factors:

a calculation method of the normalization processing is as follows:

$$Q = \{ \begin{matrix}1 & ; f \geq {f}_{top} \\ \frac{f - {f}_{down}}{{f}_{top} - {f}_{down}} & ; {f}_{top} > f > {f}_{down} \\ 0 & ; {f}_{down} \geq f\end{matrix}$$

where Q represents the factor intensity and f represents a characterization result.

In the first duty segment, for “duty duration”, a steady-state function is used to characterize the relationship between the duty duration and the fatigue degree, and the quantitative expression is as follows:

$$f = τ \cdot ( 1 - {e}^{- \frac{t}{τ}} ) ;$$

in the formula, t represents the duty duration, and τ represents a constant in the functional expression of the relationship between the duty duration and the fatigue degree.

For “duty start time” and “duty end time”: within the working scope of the two first factors, a simple circadian rhythm function is used to characterize the relationship between the duty start time/the duty end time and the fatigue degree, and the quantitative expression is as follows:

$$f = \{ \begin{matrix}0.5 \cdot cos ( \frac{2 π ( td - {td}_{h} )}{24} ) + 0.5 , & {td}_{l 1} < td < {td}_{l 2} \\ 0 , & td \leq {td}_{l 1} or {td}_{l 2} \leq td\end{matrix}$$

where td represents the starting/ending time of duty; a duty starting or ending between tdₗ₁ and tdₗ₂ has an influence on fatigue, and a duty starting or ending at tdₕ has the strongest influence on fatigue. When td is beyond tdₗ₁ point to tdₗ₂ point, the value of the quantitative characterization is 0.

For “take-off and landing time”: within the working scope of the first factor, a quantitative expression of the influence of the take-off and landing time of a flight task in one duty on the whole duty fatigue is as follows:

$$f = {\sum }_{i = 1}^{nf} \{ \begin{matrix}0.5 \cdot cos ( \frac{2 π ( {tf}_{i} - {tf}_{h} )}{24} ) + 0.5 , & {tf}_{l 1} < {tf}_{i} < {tf}_{l 2} \\ 0 , & {tf}_{i} \leq {tf}_{l 1} or {tf}_{l 2} \leq {tf}_{i}\end{matrix}$$

where in the formula, tf₁, tf₂, . . . , tf_{nf} are take-off and landing time points of nf tasks after tfₗ₁ and before tfₗ₂; taking-off and landing between tfₗ₁ and tfₗ₂ have an influence on fatigue, and taking-off and landing at tfₕ have a strong influence on fatigue.

For “stop-over duration”: within the working scope of the first factors, a quantitative expression of the influence of the stop-over duration in one duty on the whole duty fatigue is as follows:

$$f = {\sum }_{i = 1}^{nw} \{ \begin{matrix}\frac{{tw}_{i} - {tw}_{l 1}}{{tw}_{h} - {tw}_{l 1}} , & tw \leq {tw}_{h} \\ 1 - \frac{{tw}_{i} - {tw}_{h}}{{tw}_{l 2} - {tw}_{h}} , & tw > {tw}_{h}\end{matrix}$$

where tw₁, tw₂, . . . , tw_{nw} are nw stop-over durations after twₗ₁ and before twₗ₂; the stop-over duration between twₗ₁ and twₗ₂ has an influence on fatigue; twₕ represents a critical stop-over duration during which guest rest should be arranged according to the plan, and when the stop-over duration is twₕ, it has the strongest impact on fatigue.

For “flight direction and crossing time zones”: a quantitative expression of the influence of nz times of crossing time zones in one duty on the whole duty fatigue is as follows:

$$f = {\sum }_{i = 1}^{nz} {dir}_{i} \cdot {tz}_{i}$$

where tz₁, tz₂, . . . , tz_{nz} are numbers of latitude and longitude time zones spanned by nz tasks; dir₁, dir₂, . . . , dirₚ represent impact coefficients between the flight direction and the flight string fatigue, and if the number of cross-time zones is within the lower limit of fatigue, dir=0; when the number of cross-time zones impacts on fatigue, dir=1 when flying west, dir=dir′ when flying east, and dir′ represents an overall fatigue ratio between the eastbound flight route and the westbound flight route.

For “airport difficulty”: a quantitative expression of the influence of the airport difficulty of np flight tasks landing at the airport in one duty on the whole duty fatigue is as follows:

$$f ( p ) = {\sum }_{i = 1}^{np} {p}_{i}$$

where p₁, p₂, . . . , pₙₚ respectively represent difficulty scores of np landing airports; difficulties of the airports are classified and scored according to altitude, terrain, crosswind and landing procedures of the airports, and the classification and scoring depends on the pilot's evaluation.

For “pre-order duty and rest”: the quantitative expression within the working scope of the first factors is as follows:

$$f = \frac{sco}{tb}$$

where sco represents an assigned value of the pre-order duty, and tb represents a number of interval hours between this duty and the pre-order duty; a first duty or interval hours tb higher than a full rest critical time tbₕ in the flight string has no effect on the duty fatigue, that is, the quantitative characterization is equal to 0.

For “number of flight segments”: the quantitative expression of the number of flight segments is the number of flight segments itself.

For “staffing”, the quantitative expression of the staffing is as follows:

f=ca+fo·ab1+so·ab2

where ca, fo and so represents numbers of the captains, the first officers and the second officers respectively; ab1 and ab2 represents flight strength ratios of the first officer and the second officer to the captain respectively, and the specific ratios are obtained by scoring pilots through investigation.

The calculation module is used for calculating first fatigue values of the duty period segments based on the weight coefficients and the factor intensities; the specific working process includes:

a first fatigue value F of each duty segment is calculated by the above-mentioned weight coefficient W and the factor intensity Q, and the specific calculation method is as follows:

$$F = α \cdot {\sum }_{i = 1}^{m} ( {Q}_{i} \cdot {W}_{i} )$$

where α represents an adjustment coefficient used for modifying an output range of the model; m represents a number of first factors affecting flight string fatigue; Qᵢ and Wᵢ are a factor intensity and a weight coefficient of the i-th first factor respectively.

The analysis module is used for calculating a second fatigue value of the whole flight string based on the first fatigue values; and determining a flight string fatigue grade based on the second fatigue value.

The method for calculating the second fatigue value of the whole flight string by the analysis module is as follows:

First, averaging the first fatigue values F of each duty segment to obtain an average quantized value R̅F̅ of the duty fatigue degree in the whole flight string, and the calculation formula is as follows:

$$\overline{RF} = \frac{1}{n} {\sum }_{i = 1}^{n} {F}_{i}$$

where n represents number of duty segments in the flight string;

then, calculating a standard deviation σ of the fatigue degree of n duty segments in the flight string according to the fatigue degree quantified value Fᵢ of each duty segment and the average quantized value R̅F̅ of the duty fatigue degree in the whole flight string, and the formula is as follows:

$$σ = \sqrt{\frac{1}{n} {\sum }_{i = 1}^{n} {( {F}_{i} - \overline{RF} )}^{2}}$$

then, calculating a skewness coefficient S of the fatigue degree of n duty segments in the flight string according to fatigue degree quantified value Fᵢ of each duty segment, the average quantized value R̅F̅ of the duty fatigue degree in the whole flight string and the standard deviation σ, and the formula is as follows:

$$S = {\sum }_{i = 1}^{n} \frac{{( {F}_{i} - \overline{RF} )}^{3}}{{σ}^{3}}$$

finally, calculating TF representing the second fatigue value of the whole flight string according to the average quantized value R̅F̅ of the duty fatigue degree of n duty segments in the flight string and the skewness coefficient S, and the formula is as follows:

TF=RF+S.

A method for determining the fatigue grade of the flight string based on the second fatigue value includes:

when TF>80, the fatigue grade is Grade IV;

when 80≥TF>50, the fatigue grade is Grade III;

when 50≥TF>20, the fatigue grade is Grade II;

when TF≤20, the fatigue grade is Grade I;

where the fatigue grade Grade IV represents that the flight sequence task arrangement may make people extremely tired; the fatigue Grade III represents that the flight sequence task arrangement may make people highly tired; the fatigue Grade II represents that the flight sequence task arrangement may make people generally tired; and the fatigue Grade I represents that the flight schedule may make people moderately tired (or not tired).

The above-mentioned embodiment is only a description of the preferred mode of the disclosure, and does not limit the scope of the disclosure. Under the premise of not departing from the design spirit of the disclosure, various modifications and improvements made by ordinary technicians in the field to the technical scheme of the disclosure shall fall within the protection scope determined by the claims of the disclosure.

What is claimed is:

1. A method for evaluating a flight string fatigue grade based on task information, comprising:
collecting task information of a flight string, and extracting first factors influencing a flight string fatigue degree based on the task information;
constructing an index evaluation system based on the first factors, and calculating a weight coefficient of each of the first factors;
carrying out a segment processing on the task information to obtain duty period segments; carrying out a quantitative characterization on the each of the first factors to obtain factor intensities of the duty period segments;
calculating first fatigue values of the duty period segments based on weight coefficients and the factor intensities; and
calculating a second fatigue value of the whole flight string based on the first fatigue values; and determining a flight string fatigue grade based on the second fatigue value.

2. The method for evaluating the flight string fatigue grade based on task information according to claim 1, wherein the first factors comprise: a duty duration, a duty start time, a duty end time, a take-off and landing time, a stop-over duration, a flight direction and crossing time zones, an airport difficulty, a pre-order duty and rest, a number of flight segments and staffing.

3. The method for evaluating the flight string fatigue grade based on task information according to claim 1, wherein a method for constructing the index evaluation system comprises:
classifying the first factors to obtain first-level indexes;
taking the first factors comprised in the first-level indexes as second-level indexes; and
constructing the index evaluation system based on the first-level indexes and the second-level indexes.

4. The method for evaluating the flight string fatigue grade based on task information according to claim 3, wherein the first-level indexes comprise:
time planning factors, environmental factors and workload factors.

5. The method for evaluating the flight string fatigue grade based on task information according to claim 1, wherein a method for obtaining the factor intensities comprises:
carrying out the quantitative characterization on the first factors, and setting an upper limit fₜₒₚ and a lower limit f_{down} of an influence of a quantitative characterization result on duty fatigue for first factors with not-normalized quantitative characterization; and
carrying out a normalization processing on quantized first factors to obtain a factor intensity of the each of the first factors.

6. The method for evaluating the flight string fatigue grade based on task information according to claim 5, wherein a calculation method of the normalization processing is as follows:
$$Q = \{ \begin{matrix}1 & ; f \geq {f}_{top} \\ \frac{f - {f}_{down}}{{f}_{top} - {f}_{down}} & ; {f}_{top} > f > {f}_{down} \\ 0 & ; {f}_{down} \geq f\end{matrix}$$
wherein Q represents the factor intensity and f represents a characterization result.

7. A system for evaluating a flight string fatigue grade based on task information, comprising a collection module, a system construction module, a processing module, a calculation module and an analysis module;
wherein the collection module is used for collecting task information of a flight string, and extracting first factors influencing a flight string fatigue degree based on the task information;
the system construction module is used for constructing an index evaluation system based on the first factors, and calculating a weight coefficient of each of the first factors;
the processing module is used for carrying out a segment processing on the task information to obtain duty period segments; carrying out a quantitative characterization on the each of the first factors to obtain factor intensities of the duty period segments;
the calculation module is used for calculating first fatigue values of the duty period segments based on weight coefficients and the factor intensities; and
the analysis module is used for calculating a second fatigue value of the whole flight string based on the first fatigue values; and determining a flight string fatigue grade based on the second fatigue value.

8. The system for evaluating the flight string fatigue grade based on task information according to claim 7, wherein a method for constructing an evaluation index by the system construction module comprises:
classifying the first factors to obtain first-level indexes;
taking the first factors contained in the first-level indexes as second-level indexes; and
constructing the index evaluation system based on the first-level indexes and the second-level indexes.

9. The system for evaluating the flight string fatigue grade based on task information according to claim 7, wherein a method for obtaining the factor intensities by the processing module comprises:
carrying out the quantitative characterization on the first factors, and setting an upper limit fₜₒₚ and a lower limit f_{down} of an influence of a quantitative characterization result on duty fatigue for first factors with not-normalized quantitative characterization; and
carrying out a normalization processing on quantized first factors to obtain a factor intensity of the each of the first factors.

10. The system for evaluating the flight string fatigue grade based on task information according to claim 9, wherein a calculation method of the normalization processing is as follows:
$$Q = \{ \begin{matrix}1 & ; f \geq {f}_{top} \\ \frac{f - {f}_{down}}{{f}_{top} - {f}_{down}} & ; {f}_{top} > f > {f}_{down} \\ 0 & ; {f}_{down} \geq f\end{matrix}$$
wherein Q represents the factor intensity and f represents a characterization result.
